(19) United States
(12) Patent Application Publication
(10) Pub. No.: US 2006/0006643 A1
(43) Pub. Date: Jan. 12, 2006

(54) Connector for landscape irrigation pipe and method of using the same

(76) Inventor: Lon Schultz, Palm Springs, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 10/958,919

(22) Filed: Oct. 5, 2004

Related U.S. Application Data
(60) Provisional application No. 60/586,091, filed on Jul. 7, 2004.

(51) Int. Cl. F16L 33/00

(52) U.S. Cl. 285/239

(57) ABSTRACT

A connector having a frusto-conical front member and a recessed elongated cylindrical land with a plurality of barbs for coupling to a tube. The frusto-conical member includes a first barb that engages with the inner surface of the tube and the elongated cylindrical land defines a space that provides a sealing area which acts like a lock and traps the walls of the tube to aid in both the perfection of a seal between the tube and the connector and increases the pull-off resistance of the connector.

The present application is related to U.S. Provisional Patent Application Ser. No. 60/586,091, filed on Jul. 7, 2004, which is incorporated herein by reference and to which priority is claimed pursuant to 35 USC 119.

### BACKGROUND OF THE INVENTION

1. Field of the Invention

The invention relates to the field of water pipe fittings or connectors and, more particularly, to a connector body having an improved barb and landing design to improve the seal established between the connector and a tubing element.

2. Description of the Prior Art

Connectors are used daily in landscaping operations for joining flexible tubing, tube, and similar cylindrical members to each other. A typical connector comprises a rigid tubular body adapted to fit in the inner circumference of a free end of the flexible tubing. Such a connector often adopts barb members integrated on its outer circumference. These barb members are force fit into the flexible tubing and have sharp edges to assist in retaining the flexible tubing on the tubular connector. U.S. Pat. No. 3,711,130 to Betzler, U.S. Pat. No. 5,853,202 to Li et al., and U.S. Pat. No. 5,542,712 all disclose these or similar tubular connectors.

Conventional connectors are usually formed with integral barb members having sharp edges and no surface area to contact the inner surface of the flexible tubing. The barbs immediately connect the tubing, providing a seal, but provide limited surface from which secure gripping is attained.

Conventional connectors are not compatible with tubing at higher water pressures and temperatures in that a proper seal is not maintained. Furthermore, when thinner and/or softer tubes are used, traditional connectors cause failures at higher temperatures because of the increasing flexibility of the tubing. Conventional connectors have little to no locking capability, so the tubing connection often times leaks or can completely vacate the connector as heat and pressure escalate.

### BRIEF SUMMARY OF THE INVENTION

Accordingly, it is an object of this invention to provide a connector for landscape irrigation pipe that can maintain a seal under higher temperatures and pressures. This invention also provides the art with a simple, inexpensive connector that overcomes the shortcomings of the prior art described above.

Generally, this invention provides a connector for use with irrigation tubing, providing a mechanical lock between the connector and the water tubing. The connector has a generally cylindrical body with an enlarged end. The connector has a distal first end adapted to receive a tube comprising a frusto-conical member, an adjacent elongated land, and a plurality of longitudinally spaced circumferential barbs, and a second end adapted to be coupled to the tubing. The elongated land creates a mechanical locking mechanism that enables the connector to operate at higher temperatures and pressures.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is an enlarged side view of the connector and an unattached tube.

FIG. 2 is an enlarged side view of the tube affixed to the connector, with the connector being encompassed by the tube.

FIG. 3 is an isometric view of the connector.

FIG. 4 is a section view taken along line A of FIG. 1.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

A connector 10 of the type for connecting a landscaping apparatus with a pipefitting is generally shown at 10 in the FIGS.

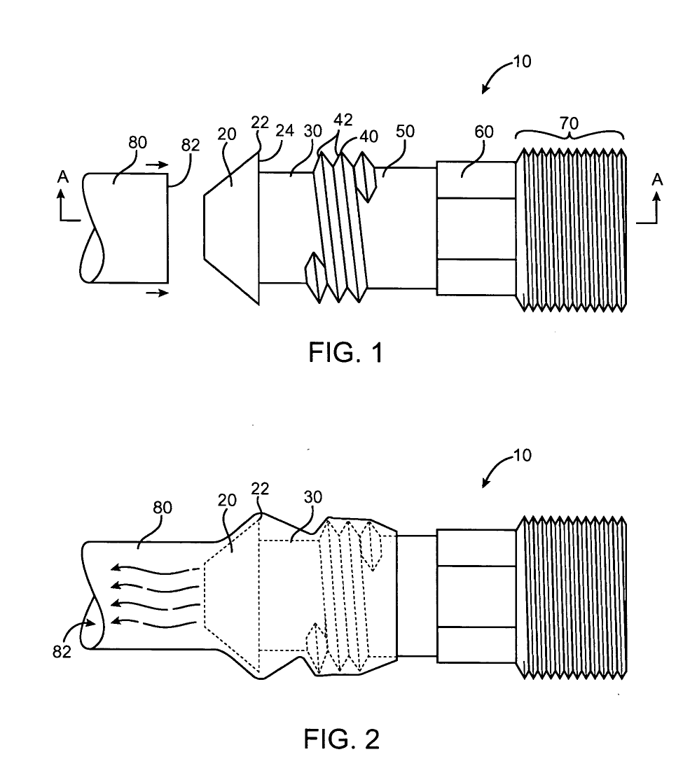

Referring to FIG. 1, the connector 10, the connector 10 has a distal first end that is adapted to receive tubing 80, and a proximal second end that is adapted to be coupled to tubing 80. The first end comprises a frusto-conical member 20 having a ramped surface beginning at a first end of the frusto-conical member 20 and ending at a second end that is essentially conical. This ramped surface increases in diameter and has an essentially consistent slope along a longitudinal length of the ramped surface, from the first end of the frusto-conical member 20 to the second end of the frusto-conical member 20, creating a first sealing surface. The frusto-conical member's 20 surface is angled in such a manner as to provide easier insertion of the connector 10 into the tubing 80 and extends axially along the connector creating a distal barb 22. The frusto-conical member's 20 distal barb 22 defines a first engaging surface between an inner surface 82 of the tubing 80 and an outside surface of the connector to provide a fluid seal.

The land 30 is longitudinally adjacent to the frusto-conical member with a diameter equal to or less then the minimum inner diameter of the tubing end 82 and elongated which allows the tubing to relax toward its unexpanded inner diameter after being expanded over the frusto-conical member to provide tighter coupling and sealing between the body and the tubing. The land 30 comprises a reduced diameter portion of the connector 10 and longitudinally extends from the distal barb 22 and ends at a predetermined distance from the distal barb 22, where the land 30 has a diameter equal to or less then the minimum inner diameter of the tubing end 82. The length of land 30 is predetermined by the degree of radial expansion of tubing 80 caused by barb 22 and the degree of resilience or strength of the elastic memory of the tubing 80 as it relaxes back to the smaller diameter of land 30. With a constant diameter of barb 22 the greater the elastic memory or tendency of tubing 80 to relax quickly back to its original diameter, the shorter the length of land 30. Similarly, with a constant degree of elastic memory of tubing 80, the greater diameter of barb 22, the greater the length that land 30 needs to be to obtain the desired seal.

The diameter of threads 40 is also a factor in determining the length of land 30. The greater the radial extent of threads 40, the greater the length of land 30 to allow sufficient length for the relaxation of tubing 80 against land 30 for the purpose of sealing against both land 30 and barb 22.

Having the cylindrical land 30 be recessed 24 behind the distal barb 22 allows substantial relaxation in the tubing 80, thereby providing a mechanical lock so that the tubing 80 can withstand higher temperatures and pressures. The land allows the tubing 80 to relax toward its unexpanded inner diameter 82 after being expanded over the distal barb to provide tighter coupling and sealing between the body and the tubing.

The first end further includes a second barbed surface longitudinally adjacent to the land that comprises a plurality of helical threads 40 longitudinally spaced apart and disposed between the land 30 and the second end of the body. The radial extent of threads 40 increases in the first proximal portion of the thread from the diameter of body 50 or land 30 to a predetermined constant radius. Similarly, the radial extent of threads 40 decreases from predetermined constant radius to the distal portion of the thread which descends to the diameter of body 50 or land 30. Tubing 80 is thus screwed onto threads 40 against the radial elastic resisting force of tubing 80.

Because of the spiral or helical form of threads 40, threads 40 add little to the fluidic sealing of the connector 10, but provide a convenient means whereby engagement and retention of tubing 80 onto the connector 10 is achieved under higher pressures. In the preferred embodiment of the invention the fluidic sealing surface or coupling with tubing 80 is moved forward to the distal end of connector 10 at barb 12 and away from the more proximal threads 40. The mechanical coupling between tubing 80 and connector 10 is similarly moved proximally toward threads 40 away from distal barb 22. Each of the helical threads 40 in the third section comprises a third engaging surface with the inner surface 82 of the tubing 80. Each of the helical threads 40 also provide an individual conical land 42 disposed on the outer surface of the barbs. The conical lands 42 between each barb defines a space that aids in a engagement between the tubing 80 and the connector 10 and also increases the pull-off resistance of the connector 10 with each thread 40.

It is also within the scope of the invention to render threads 40 as circular barbs with a ramped proximal and distal circular barb instead so that fluidic sealing by threads 40 is maximized at the expense of the ease of threaded engagement with tubing 80. Having three separate conical and sealing surfaces provides a more redundancy in the fluidic seal.

As shown in FIG. 2, when the tubing 80 is fitted over the frusto-conical member 20 and into the elongated cylindrical land 30 the tubing 80 can relax behind the distal barb 22, essentially providing a mechanical lock for the tubing 80 against the connector 10. This allows the water pressure and temperature to be higher and the tubing 80s to be thinner and/or softer without causing failure.

When the connector 10 is inserted into the tubing 80, the tubing 80 flexes and an inner surface 82 of the tubing 80 compresses radially inwardly onto the barbs so that the barbs can engage the inner surface 82 of the tubing 80 to prevent the connector 10 from being pulled off the tubing 80 under high pressures or higher temperatures. The threads 40 aid in the sealing of the tubing 80 once the connector has been pushed into the tubing, over the distal barb and beyond the cylindrical land 30 by turning the tubing 80 in a clockwise direction.

When the connector 10 and the tubing 80 are attached, as can be seen in FIG. 2 the water travels from the connector 10 into the tubing 80 and then into the landscaping apparatus. Because the tubing 80 is engaged and sealed by the connector 10, there are no leaks, and the connector 10 does not become pulled off of the tubing 80.

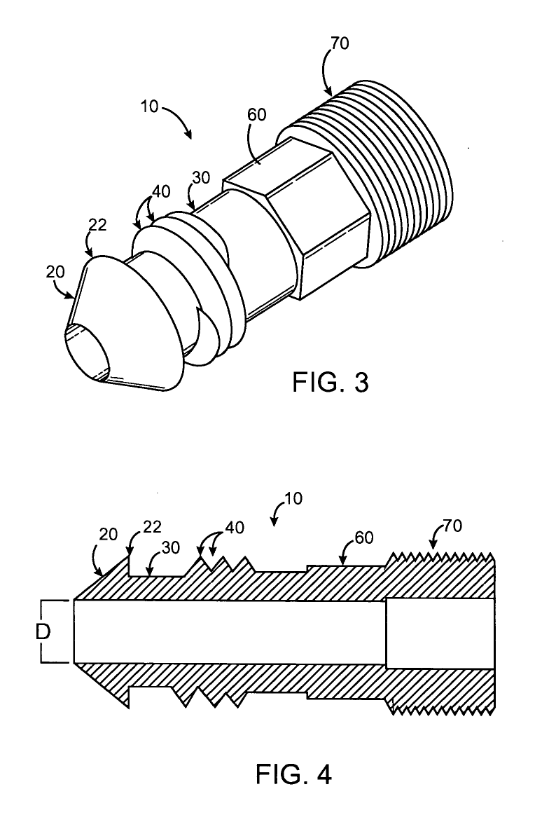

FIG. 3 is an isometric view showing that the proximal second end of the connector 10, which is only required when the connector is affixed to a female threaded fitting, can connect to a mating fitting (not shown) and includes a coupling 60 disposed at the end opposite to the end that is inserted into the tube. The coupling can include a flanged portion adapted to receive a tool, such as a wrench, to hold the coupling 60 as the connector 10 is being connected to the mating fitting (not shown). The threaded portion 70 can comprise a male or female threaded portion 70. Additionally the second end can include any suitable coupling 60 mechanisms known to those skilled in the art.

A method of coupling irrigation tubing to a connector 10 includes disposing the tubing 80 over the distal barb 22 to expand the tubing in order to allow the tubing 80 to relax its unexpanded inner diameter 82 to provide tighter coupling and sealing between the connector 10 and the tubing 80 by use of an elongated land 30 longitudinally adjacent to the distal barb 22. This expansion of the tubing 80 over the distal barb 22 and over the cylindrical land 30 causes the tubing 80 to engage with the threads 40, and allows the tubing 80 to be turned in a clockwise direction for a tighter seal with the connector 10.

FIG. 4 shows a sectional view of the connector taken along line A in FIG. 1, the connector having a generally cylinder diameter D throughout to further the efficient flow of water between the tubing 80 and the mating fitting (not shown).

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A connector for use with irrigation tubing having an inner diameter, comprising:
a generally cylindrical hollow body having a distal first end that is adapted to be coupled to the tubing and a proximal second end arranged and configured as a coupling,
the first end having a distal frusto-conical member with a surface which increases in diameter from the first end toward the second end of the body where the diameter of the frusto-conical member is greater than the inner diameter of the tubing,
a distal barb located on the frusto-conical member where the diameter of the frusto-conical member is the greatest,
an elongated land longitudinally adjacent to the frusto-conical member with a diameter equal to or less then the minimum diameter of the frusto-conical member, which land allows the tubing to relax toward its unexpanded inner diameter after being expanded over the frusto-conical member to provide tighter coupling and sealing between the body and the tubing, and
a proximal barbed surface longitudinally adjacent to the land, the second barbed surface comprising a plurality of longitudinally spaced circumferential barbs longitudinally spaced apart and disposed between the land and the second end of the body.

2. The connector of claim 1, wherein the surface of the frusto-conical member is essentially conical having an essentially consistent slope along a longitudinal length of the surface.

3. The connector of claim 1, wherein the frusto-conical member extends axially from the connector defining a first sealing surface between the outer surface of the connector and the tubing.

4. The connector of claim 1, wherein the frusto-conical member comprises a first barb at the proximal end of the frusto-conical member, the first barb having a diameter greater than the elongated land.

5. The connector of claim 4, wherein the first barb abuts an inner surface of the tubing to grip the tubing and to create a first engaging surface.

6. The connector of claim 4, wherein the land comprises a reduced diameter portion of the connector and longitudinally extends proximally from the first barb and ends at a predetermined distance from the first barb.

7. The connector of claim 1, wherein the land is cylindrical.

8. The connector of claim 4, wherein the land defines a space so as to provide a sealing area that acts as a lock and traps the walls of the tubing to aid in both the perfection of a seal between the tubing and the connector and to increase the pull-off resistance of the connector by allowing the tubing to relax behind the first barb.

9. The connector of claim 1, wherein the tubing has an inner surface and where each of the longitudinally spaced circumferential barbs comprises a third engaging surface with the inner surface of the tubing.

10. The connector of claim 7, wherein each of the longitudinally spaced circumferential barbs includes an individual conical land defining a space to provide a sealing area that acts as a lock and traps the walls of the tubing to aid in both the perfection of a seal between the tubing and the connector and increase the pull-off resistance of the connector.

11. The connector of claim 1, wherein the coupling includes a connecting portion extending longitudinally to the second end of the body.

12. The connector of claim 1, wherein the coupling includes a flanged portion adapted to receive a tool.

13. The connector of claim 1, wherein the coupling comprises and enlarged portion and a threaded portion defined in the enlarged portion of the connector.

14. A tubular connector for use with tubing and a pipe fitting, comprising:
a generally cylindrical body having a first distal end that is adapted to be coupled with the tubing and a second proximal end that is adapted to be coupled with the pipe fitting;
a frusto-conical member having a ramped surface, and a distal and proximal end, where the ramped surface increases in diameter from its distal to proximal ends as a function of longitudinal position toward the proximal second end of the body,
a cylindrical elongated land yielding a greater amount of surface contact between an inner surface of the tubing and an outer surface of the body enabling the tubing to relax behind the frusto-conical member, wherein the elongated cylindrical land further comprises a reduced diameter of the body that begins at the frusto-conical member and ends at a predetermined distance from the proximal end of the frusto-conical member,
a plurality of longitudinally spaced circumferential barbs disposed between the elongated cylindrical land and the second end, wherein each the longitudinally spaced circumferential barbs include a separate land; and
the second end comprising a midsection, coupling and threaded portion.

15. A method of coupling irrigation tubing having an inner diameter to a connector, comprising:
disposing the tubing over a distal barb provided on a generally cylindrical hollow body to expand the tubing;
allowing the tubing to relax toward its unexpanded inner diameter after being expanded over the distal barb to provide tighter coupling and sealing between the body and the tubing by use of an elongated land longitudinally adjacent to the distal barb where the land has a diameter equal to or less then the minimum diameter of the distal barb, and
engaging the tubing with a proximal barb longitudinally adjacent to the land.

16. The method of claim 15 where disposing the tubing over a distal barb comprises disposing the tubing over a frusto-conical member distally positioned on the connector.

17. The method of claim 15 where allowing the tubing to relax toward its unexpanded inner diameter comprises allowing the tubing to relax over a predetermined longitudinal length extending proximally from the distal barb.

18. The method of claim 15 where disposing the tubing over a distal barb comprises gripping the tubing and creating an engaging surface contact between the distal barb and tubing.

19. The method of claim 15 where allowing the tubing to relax comprises providing a sealing area that acts as a lock and traps the walls of the tubing to aid in both the perfection of a seal between the tubing and to increase the pull-off resistance by allowing the tubing to relax behind the distal barb.

20. The method of claim 15 where engaging the tubing with a proximal barb comprises engaging the inner surface of the tubing with a plurality of circumferential barbs proximal to the land.

21. The method of claim 20 where engaging the inner surface of the tubing comprises engaging the inner surface of the tubing with the plurality of circumferential barbs, each of which includes an individual conical land defining a space to provide a sealing area that acts as a lock and traps the walls of the tubing to aid in both the perfection of a seal with the tubing and to increase the pull-off resistance.

22. A connector for coupling to irrigation tubing having an inner diameter to a pipe fitting comprising:
a generally cylindrical hollow body having a distal and proximal end;
a distal barb having a radial dimension provided on the body to expand the tubing and to provide fluidic sealing;
an elongated land longitudinally adjacent to the distal barb where the land has a radial dimension equal to or less then a minimum radial dimension of the distal barb to allow the tubing to relax toward its unexpanded inner diameter after being expanded over the distal barb to provide tighter coupling and sealing between the distal barb and the tubing; and
a proximal threading longitudinally adjacent to the land to mechanically couple to the tubing.

23. The connector of claim 22 further comprising a pipe fitting coupling proximal to the proximal threading.
